(19) United States
(12) Patent Application Publication
(10) Pub. No.: US 2021/0337373 A1
(43) Pub. Date: Oct. 28, 2021

(54) LOW-COST SINGLE MOTHERBOARD COMPUTER WITH INTEGRATED LTE/5G MODEM

(71) Applicant: T-Mobile USA, Inc., Bellevue, WA (US)

(72) Inventor: Jonathan Soini, Bellevue, WA (US)

(21) Appl. No.: 16/858,415

(22) Filed: Apr. 24, 2020

(51) Int. Cl. H04W 8/18; H04W 48/18; H04W 8/20; H04W 12/00; H04W 12/06; H04W 88/06; G06F 13/38

(52) U.S. Cl. CPC H04W 8/183; H04W 48/18; H04W 8/205; G06F 13/385; H04W 12/06; H04W 88/06; H04W 12/0023

(57) ABSTRACT

The disclosed device is a low-cost single motherboard computer with an integrated LTE/5G modem that can automatically connect to a cellular network and provide Internet connection to devices in the surrounding environment where no cable or Wi-Fi is available. The device can include a touchscreen, multiple general-purpose input output (GPIO) pins, and multiple USB ports. Through the GPIO and USB ports, the device allows connection of various external devices such as sensors to measure acceleration, orientation, temperature, pollution, humidity, etc. The device can be installed close to the location where the data is gathered, and can perform the needed computation locally, therefore improving response times, and saving network bandwidth. The device can be enclosed within a waterproof case and be able to operate in a humid or watery environment.

### BACKGROUND

Computers in various forms such as a personal computer (PC), a tablet, a mobile phone are ubiquitous today. Generally, they are expensive, and not designed for easy programming. For example, a user needs an extensive development suite kit to configure a PC for programming. Further, the type of devices that can be plugged into a PC are predefined by the types of ports built into the PC, generally USB ports.

In addition, computing today is moving towards cloud computers, such as remote servers, that require input data to be transferred from the local computer to the remote server, and the result to be transferred back to the local computer. The transfer of data back-and-forth consumes network bandwidth and increases the response time needed to obtain the result.

### BRIEF DESCRIPTION OF THE DRAWINGS

FIG. 1 shows a low-cost computer having single motherboard with an LTE/5G modem.

FIG. 2 shows a dongle or additional functionality module attached to the computer.

FIG. 3 shows prompts to automatically detect and connect to an available cellular network.

FIGS. 4A-4B show a flowchart of a method to reduce bandwidth consumption of the cellular network and increase response times by performing a local computation using a portable device.

FIG. 5 shows front, back, side views, as well as an internal view of a low-cost single motherboard computer.

FIG. 6 shows an add-on module that can attach to the GPIO pins.

### DETAILED DESCRIPTION

The disclosed device is a low-cost single motherboard computer (single-board computer—SBC) with an integrated LTE/5G modem that can automatically connect to a cellular network and provide Internet connection to devices in the surrounding environment where no cable or Wi-Fi is available. The single motherboard computer can be a Raspberry Pi computer, while the integrated LTE/5G modem can communicate using an Internet of Things (IoT) protocol. The device can include a touchscreen, multiple, general purpose input output (GPIO) pins, and multiple USB ports. Through the GPIO and USB ports, the device allows connection of various external devices such as sensors to measure acceleration, orientation, temperature, pollution, humidity, etc. The device can be used as a controller of Narrowband Internet of Things (NB-IoT) devices. The device can be installed close to the location where the data is gathered, and can perform the needed computation locally, therefore improving response times, and saving network bandwidth. The device can be enclosed within a waterproof case and be able to operate in a humid or watery environment.

The device can store in a flash or a PROM memory a base OS version, and drivers for the touch screen, GPIO pins, USB ports, and for the modem. Further, the memory can store a simple application, launched at startup, that detects a strongest or best cell signal and automatically attempts to register the device with the cellular network, including asking the user for login credentials (e.g. user ID and password).

Various examples of the invention will now be described. The following description provides certain specific details for a thorough understanding and enabling description of these examples. One skilled in the relevant technology will understand, however, that the invention may be practiced without many of these details. Likewise, one skilled in the relevant technology will also understand that the invention may include many other obvious features not described in detail herein. Additionally, some well-known structures or functions may not be shown or described in detail below, to avoid unnecessarily obscuring the relevant descriptions of the various examples.

The following description and drawings are illustrative and are not to be construed as limiting. Numerous specific details are described to provide a thorough understanding of the disclosure. However, in certain instances, well-known or conventional details are not described in order to avoid obscuring the description. Various features are described which may be exhibited by some examples or embodiments and not by others. Similarly, various requirements are described which may be requirements for some embodiments but no other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section

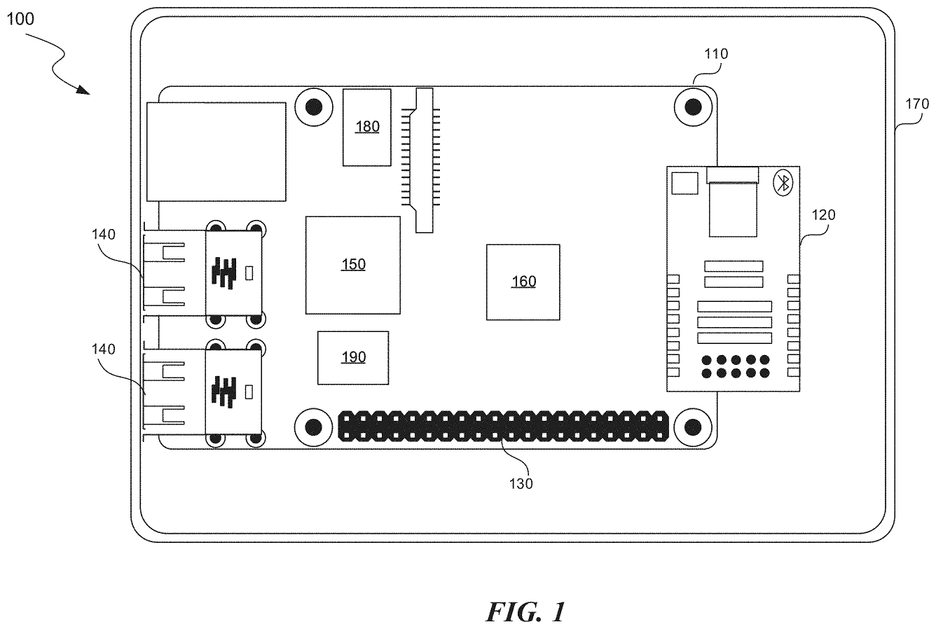

FIG. 1 shows a low-cost computer 100 having single motherboard 110 with an LTE/5G modem 120. The computer 100 has a predefined size, e.g. not exceeding 100 mm by 60 mm. The computer's small size makes the computer portable, and can be carried in a palm, strapped to a scooter, a bike, or a trunk of a car. To prevent theft of the portable computer 100, the computer can include a Kensington lock slot to secure the computer when the computer is located outdoors or at a remote, unsupervised location.

The computer 100 is a low-cost relative to other computing devices such as laptops, desktops, smartphones, and tablets (e.g. less than $200) and can serve as an inexpensive prototyping tool. The low cost of the computer 100 along with the computer's ability to connect to a cellular network through the modem 120, enables the computer to provide Internet access to places without Internet cables, such as underdeveloped areas. The modem 120 is configured to communicate through a cellular network using LTE or 5G technology and can include a Subscriber Identity Module (SIM) or an embedded SIM (eSIM). The modem 120 could include a custom antenna for LTE/5G communications and be able to fit within a housing containing the computer 100. The motherboard 110 and/or an environmentally secure enclosure 170 can include connectors for external antennas. In addition, a preprinted antenna can be included within the case 170.

The motherboard 110 can contain multiple I/O points coupled to the single motherboard, where the multiple I/O points are configured to gather sensor inputs from a surrounding environment. The multiple I/O points can include at least 40 general purpose input/output (GPIO) pins 130 and multiple USB ports 140 configured to communicate with one or more external sensors. The GPIO pins 130 and USB ports 140 are accessible at an exterior of the computer enclosure.

A GPIO pin is an uncommitted digital signal pin on an integrated circuit or electronic circuit board whose behavior—including whether it acts as input or output—is controllable by the user at run time. The user can define the purpose and behavior of the GPIO connecting an integrated circuit, such as a sensor, to the GPIO pin. A GPIO pin's state can be exposed to the software developer through one of a number of different interfaces, such as a memory mapped peripheral, or through dedicated IO port instructions. GPIO pins can be configured to be input or output, GPIO pins can be enabled/disabled, GPIO pin input values are readable (typically high or low), GPIO pin input values are writable/readable, GPIO pin input values can often be used as interrupts (IRQs), typically for wakeup events, such as transitioning a processor from a low or medium power mode to a high-power mode.

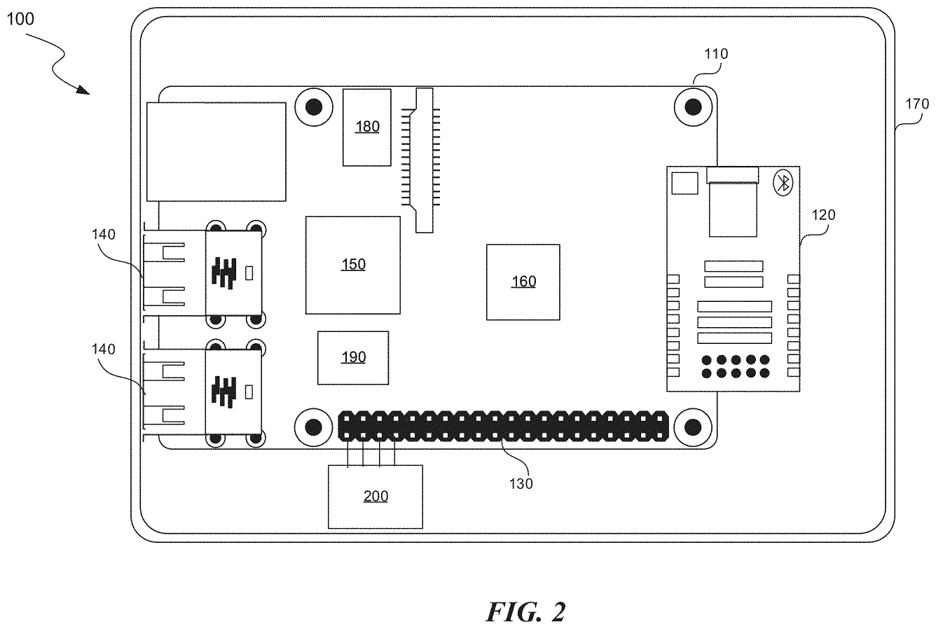

The motherboard 110 can include a processor 150, and a memory 160 in communication with the modem 120 and the multiple I/O points 130, 140. The processor can be any low power processor, such as those developed on the ARM core, Intel's Atom, etc. The memory 160 can be a flash memory a PROM. An environmentally secure enclosure 170 can enclose the motherboard 110 and the modem 120. The environmentally secure enclosure 170 can include a waterproof case, enabling the computer 100 to operate in a dusty, humid or a watery environment. The environmentally secure enclosure 170 can be extendable to accommodate additional sensors attached to the computer 100, or include environmentally sealable electrical/communication ports through which external sensors and other input or output devices can be connected to thereby couple such devices to the computer. The environmentally secure enclosure 170 can be large in size and capable of accommodating both the computer 100 as well as any external hardware coupled to the computer, such as a dongle described in FIG. 2.

The environmentally secure enclosure 170 can be made out of several parts. For example, a first part that has a set size and that covers the screen of the computer 100, and a second part that can have varying sizes to accommodate different add-on modules. For example, the second part can be sized to accommodate only the computer 100. In another example, the second part can be sized to accommodate the computer 100 and an add-on, such as the dongle described in FIG. 2.

The motherboard 110 can include a portable and limited power supply 180, such as a battery. The power supply 180 can be rechargeable through wired or wireless charging, or an external power supply such as a solar cell releasably couplable to a port on an external surface of the enclosure. The computer 100 can be easily carried around due to the small size of the computer, however unplugging the computer puts a strain on the limited power supply 180, and thus power management of the computer 100 is important. To that end, the computer 100 can include a programmable power management integrated circuit (PMIC) to allow a user to program the computer to operate in one or more power modes, e.g. using solar power during the day, but relying on batteries at night, and charging the batteries during the day when the processor 150 is in a sleep, deep sleep or other medium or low power modes.

The processor 150 is configured to reduce power consumption by operating in at least one of multiple power modes including high-power, medium power or low power mode. In the high-power mode, the processor 150 operates normally and consumes higher amounts of power compared to the medium power or low power mode. In the high-power mode, the processor 150 can consume approximately 35 microamps of power per megahertz of processing speed. When the process 150 handles all exceptions and interrupts, the processor can automatically transition to medium power or low power mode.

In the medium power mode, the processor 150 can stop the processor clock, thus stopping the processor from consuming power. In the low power mode, the processor 150 can stop the processor clock, the system clock, and switch off flash memory. Consequently, in the low power mode, the processor 150 can consume less than 200 nanoamps of power. The processor 150 can wake up from deep sleep mode upon receiving an interrupt or an exception.

The system clock is needed to synchronize all components on the motherboard. The system clock speed is set above the longest time any signal needs to propagate through any circuit on the board. The processor clock has the same purpose but is only used on the chip itself. The processor clock speed is higher than the system clock speed because the processor 150 needs to perform more operations per cycle than the motherboard 110.

The decision whether to transition the processor 150 into medium or low power mode, can be based on frequency of interrupts and exceptions received. For example, if the frequency of interrupts and exceptions in the past has been higher than a predetermined frequency, such as 100 times the system clock frequency, the processor 150 can enter medium power mode which stops the processor clock, instead of low power mode which stops the system clock. However, if the frequency of interrupts and exceptions in the past has been lower than the predetermined frequency, the processor 150 can enter the low power mode, and stop the system clock.

In one embodiment, a second low power processor 190 can be added to the motherboard 110. The low power processor 190 can handle interrupts and/or low-level exceptions. The interrupts are used to handle external events (multiple I/O points 130, 140) and exceptions are used to handle instruction faults, (division by zero, undefined opcode). For example, when the main processor 150 handles all exceptions or all high-priority exceptions, the main processor 150 can go into a medium or low power mode, while the low power processor 190 handles the incoming interrupts that do not require the main processor 150.

FIG. 2 shows an auxiliary unit dongle 200 attached to the computer 100. The dongle 200 can be an extension to the hardware functionality of the computer 100, such as an additional power source (e.g. a battery pack, power rectifier for external wind generator), a camera base, a speaker base, a microphone, a sensor such as a gyro sensor, an accelerometer, GPS receiver, etc.

The dongle 200 can be a radio frequency sensor which can detect one or more mobile devices, such as a cell phone, a watch, Fitbit, etc., in a surrounding environment, and can determine how the number of mobile devices in the surrounding environment varies over time. The sensor 200 can be installed at a location such as a store, shop, restaurant, etc. By detecting the mobile devices in the surrounding environment, the sensor 200 can monitor number of visitors at the location, and how that number varies over time. Consequently, the sensor 200 can determine peak occupancy times at the location.

The sensor 200 can be an environment sensor that can measure one or more properties of a surrounding environment such as temperature, humidity, and/or pollution. The sensor can gather the environmental data. The sensor can analyze how the properties of the surrounding environment vary over time or can send the environmental data to a cloud computer for further analysis.

The sensor 200 can be a transceiver configured to communicate using an Internet of Things (JOT) communications protocol such as Bluetooth, LTE, 5G, Narrowband Internet of Things (NB-IoT), ZigBee, Z-Wave, IEEE 802.15.4, etc. For example, the sensor 200 can communicate with a nearby device using Narrowband Internet of Things (NB-IoT) to allow the computer 100, along with the sensor 200, to be used as a hub controlling IOT devices in a home or an office.

Due to the computer's 100 small size, the computer along with the sensor 200 can be carried in a backpack or mounted on a vehicle, such as a bike, a scooter, a car, a bus, and can be carried throughout a geographic area to collect data from multiple sensors scattered about the geographic area. For example, the computer 100 and sensor 200 can collect data about signal strength of an LTE or a 5G network to inform whether and where additional cell towers and/or sectors need to be installed.

In another example, the computer 100 and sensor 200 can gather data from multiple even cheaper sensors that measure environmental properties such as pollution, temperature, wind speed, humidity, etc. The computer 100, to preserve power, can enter a low power mode, until the computer approaches an area populated with cheap sensors, from which readings need to be gathered. Upon entering an area known to have multiple cheap sensors, the computer 100 can receive a wakeup signal and can ping the cheap sensors to transmit their data to be gathered and stored at the computer 100.

Multiple computers 100 can be networked together as well and still be portable. The multiple computers 100 can be tasked to perform different collections by collecting data from different sensors. In one embodiment, multiple computers 100 can have various sensors attached to them and can each collect various measurements. One computer 100 among the multiple computers can be the coordinator computer. The coordinator computer 100 can collect and store data from the various computers 100 having various sensors collecting measurements.

The computer 100 can collect data in moving vehicles via in-vehicle diagnostic interfaces. The computer 100 can collect gas and/or atmospheric data (such as carbon monoxide levels) in building locations where power is inaccessible. The computer 100 can act as a motion or traffic counter in outdoor spaces. Three computers 100 equipped with radiofrequency (RF) radios can be networked together and used to triangulate signals from devices in communication with the three computers 100.

The computer 100 can gather the data and perform the computation using the processor 150 locally, without the need to send the data to a remote processor. The advantage of performing the computation locally within the computer 100, is that the computer 100 can operate without an Internet or a cellular connection, or with only an intermittent connection. Even if the computer 100 is reliably connected to a network, such as the Internet, the network bandwidth consumption is reduced because the data is processed locally and does not have to be transmitted through the network. In other words, the computer 100 performs data intensive processing locally, and need only provide the results of the processing externally, such as analyzing a large data set of environmental data collected locally, and sending only statistically processed data via the cellular network. Further, the response time between requesting a computation and obtaining the result of the computation is improved because the computation is performed locally, without the need to transmit data to a remote cloud server to perform the computation, and then transmit the results of the computation to the computer 100.

The device can store in a flash or a PROM memory a base OS version, and drivers for the touch screen, GPIO pins, USB ports, and for the modem. Further, the memory can store a simple application, launched at startup, that detects a strongest or best cell signal and automatically attempts to register the device with the cellular network, including asking the user for login credentials (e.g. user ID and password).

The base OS version can be the latest stable build of Linux with additional drivers for the display and modem. The modem 120 can be configured to access a predetermined cellular network, such as a T-mobile network. Periodically, telemetry can be performed on the computer 100, so customer support can identify the device 100 on the network, even if a user hasn't logged in. The computer 100 can have a pre-provisioned eSim with access to the cellular network. A startup application can direct end-user to sign up with a plan or enter their cellular network credentials to sign into to an existing billing plan. The computer 100 can access a software repository with additional applications that the end-user can download from T-Mobile, which may include updates to the existing applications and further applications built after the device 100 ships.

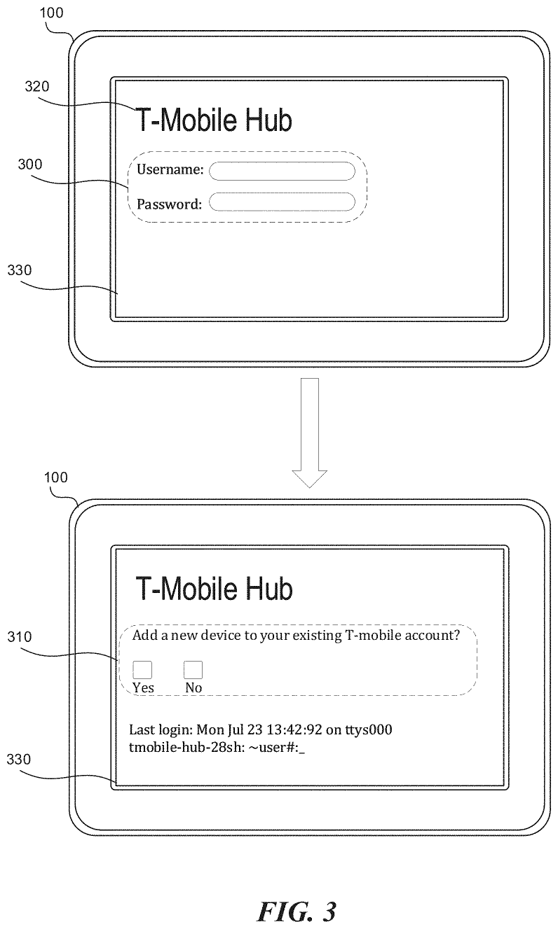

FIG. 3 shows user prompts to automatically detect and connect to an available cellular network and allow a user to easily connect the computer 102 a cellular or other network. Upon initially powering on, the modem 120 in FIGS. 1, 2 can automatically detect an available cellular network 320, such as a T-Mobile 5G network, as shown in FIG. 3. The modem 120 can automatically connect to the detected cellular network and receive an authorization query 300 from the cellular network. The authorization query 300 can be a username and password, or a phone number registered with the cellular network and a password. A user can interact with the device 100 using a touchscreen 330, such as an 800×480 or 720p capacitive touchscreen with multitouch capabilities.

The processor 150 in FIGS. 1, 2 can provide the authorization query to a user based on locally stored instructions. Upon receiving an answer to the authorization query from the user, the processor 150 can send the answer to the cellular network. The cellular network can check whether the credentials supplied by the user match a user account registered with the cellular network. After confirming the credentials, the cellular network can offer to the user through query 310 to register a device with the cellular network. Upon the user accepting the registration of the additional device, a SIM or eSIM card of the device 100 can store the international mobile subscriber identity (IMSI) number and the related key on the SIM or eSIM card of the device 100. Upon registration, every subsequent time, the user device 100 registers with the cellular network for which the device 100 has previously registered, the user device can automatically connect to the cellular network, without requiring an input from the user.

Upon receiving authorization from the cellular network, the processor 150 can obtain inputs from the multiple I/O points 130, 140 in FIG. 1, and can perform a local computation based on the input from the multiple I/O points, thereby reducing bandwidth consumption and improving response times.

Device 100 can create an Internet connection in a surrounding environment having no wired or Wi-Fi connection, by providing access to the cellular network through the modem. Further, using the transceiver 200 in FIG. 2, or the modem 120 in FIGS. 1, 2, a chain, or a mesh of multiple devices 100 can provide Internet connection in an area having no wireless or wired network.

For example, a first device 100 can be located at an edge of the cellular network, while second device 100 can be located in an area having no cellular network and no Internet. The first and the second device can communicate directly between each other using an IOT protocol. The second device can communicate with nearby devices also using an IOT protocol and can relay the requests from the nearby devices to the first device, which in turn can relay the requests to the Internet. The low cost of the device 100 makes it an attractive solution for providing Internet connectivity to unconnected and undeveloped areas.

The first and second devices can be stationary, or can be mounted on a movable object, such as a drone, and can periodically provide Internet access to various areas without cellular or Internet access. If the device 100 is mounted in a drone, the device weight can be reduced by removing the screen, thereby extending the battery life of the drone.

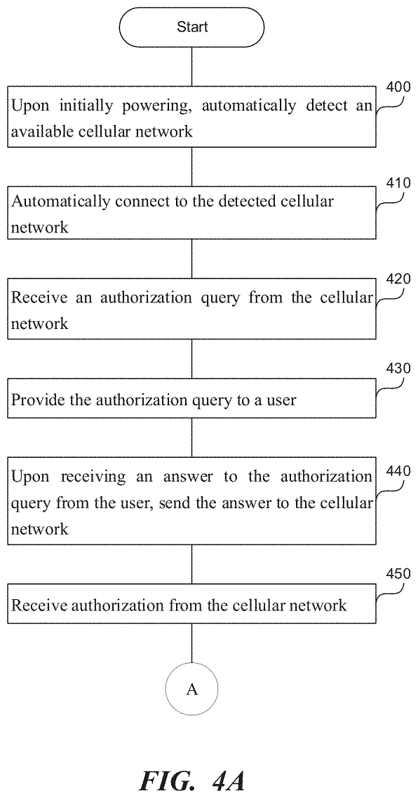

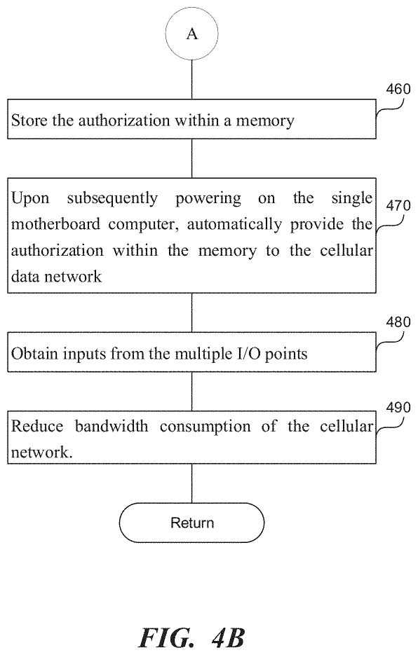

FIGS. 4A-4B show a flowchart of a method to reduce bandwidth consumption of the cellular network and increase response times by performing a local computation using a portable device 100 in FIGS. 1-3. Due to its small size, the portable device 100 can be taken to a location where the computation needs to be performed. Further, the processor 150 in FIG. 1 can perform the computation at the location of the device 100 but provide outputs of those computations to a remote location via a cellular wireless connection.

In step 400, upon initially powering on a single motherboard computer with a processor and a modem configured to communicate through a cellular network using an LTE or a 5G techno log, a hardware or software processor can automatically detect an available cellular network. In step 410, the processor 150 can automatically connect to the detected cellular network. The processor can provide the international mobile subscriber identity (IMSI) number(s) stored in the SIM/eSIM and other information stored therein to the network for authorization.

In step 420, the processor can receive an authorization query from the cellular network, the query can be generated by a locally stored routine, or both. In step 430, the processor provides the authorization query to a user. In step 440, upon receiving an answer to the authorization query from the user, the processor can send the answer to the cellular network. In step 450, the processor can receive authorization from the cellular network.

In step 460, the processor can store the received authorization, network parameters, or both within a memory of the single motherboard computer. In step 470, the processor can automatically provide the authorization within the memory to the cellular network, including after powering down and back up of the single motherboard computer. In step 480, the processor can obtain inputs from the multiple I/O points.

At start up, a command-line application can run and can present the user with two choices: 1) sign into an existing cellular network account, which would add the eSIM line in the device to that account, after user accepts the terms and additional line charge; and 2) create a new cellular network account on device with the eSIM, if the user wants to create a standalone device or the user doesn't have an account with the cellular network. The command-line application can collect enough information from the user to start. The user can later setup the account from a PC or tablet with the rest of the account details.

Due to its small size, the portable device 100 can be taken to a location where the computation needs to be performed. Further, the processor 150 can perform the computation at the location of the device 100. Consequently, in step 490, by performing a local computation based on the input from the multiple I/O points, the processor can reduce bandwidth consumption of the cellular network. Further, by not sending the data to a remote processor, such as the cloud computer, to perform computation, the processor 150 can increase response times by eliminating the need to wait for input data to be sent to a cloud computer and wait for output data to be sent to the processor 150, as well as overcoming issues related to intermittent wireless connections, such as in remote locations lacking a reliable cellular connection.

Moreover, the device 100 can create an Internet connection in a surrounding environment having no wired or wireless connection, by providing access to the cellular network through the modem. A first device 100 can be connected to a cellular network, while a second device 100 can be placed in an area where there is no cellular network. The first and the second device 100 can communicate with each other using a wireless protocol, thus enabling the second device to provide Internet connectivity. Additional devices can be connected together to create a chain or a mesh of devices providing Internet connectivity in the area without the cellular network and without Internet connectivity.

For example, a first group of devices can be placed along a perimeter of a cellular reception, so that the first group of devices can connect to the cellular network. A second group of devices can be placed in an area without the cellular network and without Internet connectivity, but where each device and the second group of devices is within wireless communication range with at least one device in the first group of devices.

The device 100 can include multiple I/O points configured to receive a sensor. The sensor can detect one or more mobile devices, such as cell phones, Fitbits, smartwatches etc., in a surrounding environment. The sensor can determine how a number of the one or more mobile devices in the surrounding environment varies over time.

The device 100 can include multiple I/O points configured to couple to an environment sensor. The environment sensor can measure one or more properties of a surrounding environment including a temperature, a humidity, a pollution, and can determine how the properties of the surrounding environment vary over time.

The device 100 can communicate with a nearby device using Narrowband Internet of Things (NB-IoT). For example, the device 100 provides Internet connectivity to nearby devices, without cellular or Internet connectivity, by using NB-IoT. In another example, the device 100 can collect data, such as environment data, from nearby devices, when device is within NB-IoT range to the other devices. In a more specific example, the device 100 can attach to a drone, flying around an area, and in the enabling the device 100 to collect data from nearby devices.

Power preservation can be important for the device 100, and particularly when the device 100 is moving, and is relying on the limited power supply. For example, the device 100 can reduce power consumption of the limited power supply by operating a processor in at least one of multiple power modes including high-power, medium power or low power mode. In the medium power mode, the processor clock can be stopped, while in the low power mode a system clock and flash memory can be stopped. The processor 100 can transition from the high-power mode to medium power or low power mode upon completion of handling pending interrupts and exceptions.

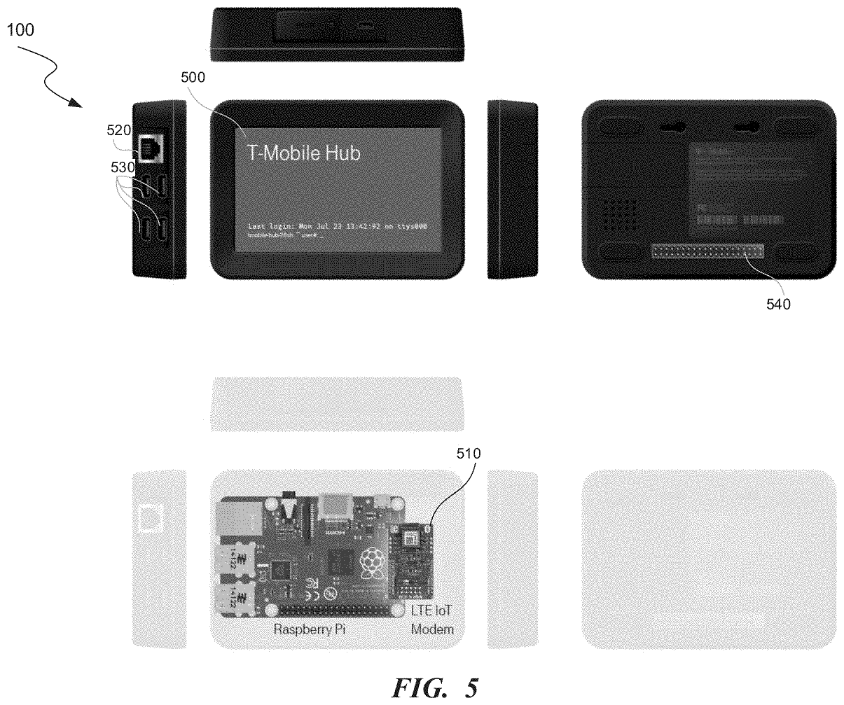

FIG. 5 shows front, back, side views, as well as an internal view of a low-cost single motherboard computer. The low-cost single motherboard computer 100 can be a Raspberry Pi. The computer 100 can contain a touchscreen display 500. Upon powering on, an LTE/5G modem 510 can detect an available cellular network and display the information regarding the cellular network on the touchscreen the display 500. The computer 100 can include an ethernet port 520, as well as USB ports 530. In addition, the back of the computer 100 can expose multiple GPIO pins 540.

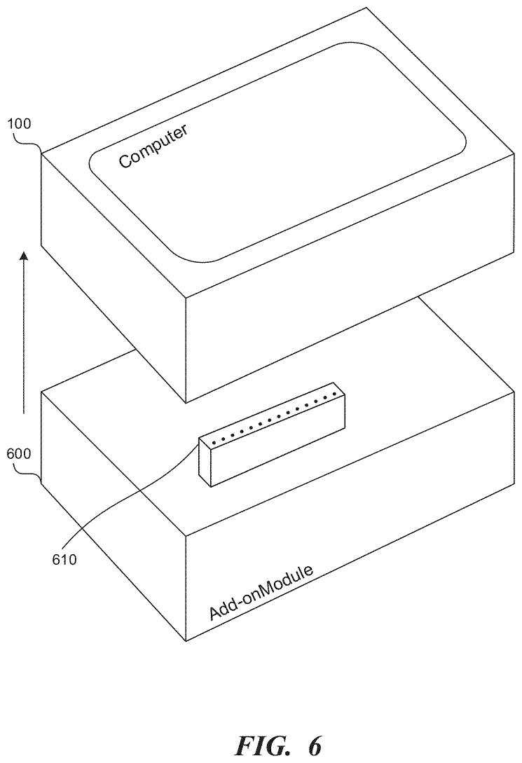

FIG. 6 shows an add-on module that can attach to the GPIO pins 540 in FIG. 5. The add-on module 600 can have the same height and width as the computer 100. The add-on module 600 can have pins 610 that can attach to the GPIO pins 540 of the computer 100. The add-on module 600 can be a battery pack for the computer 100, a sensor, and/or a dongle described in FIG. 2.

### REMARKS

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements.

Any patents and applications and other references noted above, including U.S. Pat. No. 10,147,096, and any that may be listed in accompanying filing papers, are incorporated herein by reference in the entirety, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

To reduce the number of claims, certain aspects of the invention are presented below in certain claim forms, but the applicant contemplates the various aspects of the invention in any number of claim forms. For example, while only one aspect of the invention is recited as a means-plus-function claim under 35 U.S.C sec. 112(f), other aspects may likewise be embodied as a means-plus-function claim, or in other forms, such as being embodied in a computer-readable medium. (Any claims intended to be treated under 35 U.S.C. § 112(f) will begin with the words “means for”, but use of the term “for” in any other context is not intended to invoke treatment under 35 U.S.C. § 112(f).) Accordingly, the applicant reserves the right to pursue additional claims after filing this application to pursue such additional claim forms, in either this application or in a continuing application.

1. A system comprising:
a single motherboard computer having a predefined size,
wherein the single motherboard computer is a Raspberry Pi configured to couple to an unmanned vehicle;
a modem coupled to the single motherboard computer,
wherein the modem is configured to communicate through a cellular network using LTE or 5G technology, and
wherein the modem includes a Subscriber Identity Module (SIM) or embedded SIM (eSIM);
an environmentally secure enclosure for containing the single motherboard computer and the modem within the enclosure;
multiple I/O points coupled to the single motherboard computer,
wherein the multiple I/O points are configured to gather sensor inputs from a surrounding environment,
wherein the multiple I/O points include at least 40 general purpose input output (GPIO) pins and multiple USB ports configured to communicate with an external sensor, and
wherein the GPIO and USB ports are accessible at an exterior of the enclosure;
a sensor connected to an I/O point among the multiple I/O points and configured to collect data about signal strength of an LTE or a 5G network;
a processor and memory integrated into the single motherboard computer and in communication with the modem and the multiple I/O points,
wherein the memory is preprogrammed with stored instructions when the system is initially received by a user, and
wherein the stored instructions, when executed by the processor, implement operations comprising:
upon initially powering on, automatically detect an available cellular network;
automatically connect to the detected cellular network;
receive an authorization query from the cellular network, and provide the authorization query to the user;
upon receiving an answer to the authorization query from the user, send the answer to the cellular network;
receive authorization from the cellular network;
create, by the single motherboard computer, an Internet connection for a device in the surrounding environment having no wired or wireless connection to the Internet by:
establishing a connection with the device using a short distance wireless communication protocol; and,
providing, to the device, access to the detected cellular network using the modem;
upon receiving authorization from the cellular network, obtain inputs from the sensor; and
perform a local computation based on the input from the sensor to generate a coverage map based on the signal strength of the LTE or the 5G network, thereby reducing bandwidth consumption and improving response times.

2. The system of claim 1, wherein the predefined size does not exceed 100 mm by 60 mm, and wherein the system includes a rechargeable battery, secured within the enclosure, and coupled to provide power to the single motherboard computer.

3. The system of claim 1, further comprising:
a limited power supply; and
the processor configured to reduce power consumption by operating in at least one of multiple power modes including a high-power, a medium power or a low power mode,
wherein the processor transitions from the high-power mode to the medium power or the low power mode upon handling pending interrupts and exceptions.

4. The system of claim 1, further comprising:
a limited power supply; and
the processor configured to reduce power consumption by operating in at least one of multiple power modes including a high-power, a medium power or a low power mode,
wherein the medium power mode stops a processor clock, and the low power mode stops a system clock and a flash memory.

5. The system of claim 1, the operations further comprising:
create the Internet connection in the surrounding environment having no wired or Wi-Fi communications connection, by providing access to the cellular network through the modem.

6. The system of claim 1, wherein the single motherboard computer includes the multiple I/O points configured to receive a second sensor, the operations further comprising:
detect, by the second sensor, a mobile device in the surrounding environment; and
determine how a number of the mobile device in the surrounding environment varies over time.

7. The system of claim 1, wherein the single motherboard computer includes the multiple I/O points configured to couple to an environment sensor, the operations further comprising:
measure by the environment sensor a property of the surrounding environment including a temperature, humidity, or pollution; and
determine how the property of the surrounding environment varies over time.

8. The system of claim 1, the operations further comprising:
communicate with a nearby device using Narrowband Internet of Things (NB-IoT).

9. The system of claim 1, wherein the environmentally secure enclosure comprises a waterproof case.

10. A method comprising:
upon initially powering on a single motherboard computer with a processor and a modem configured to communicate through a cellular network using an LTE or a 5G technology, automatically detecting an available cellular network,
wherein the single motherboard computer is configured to couple to an unmanned vehicle, and
wherein the single motherboard computer comprises a Raspberry Pi;
automatically connecting to the detected cellular network;
receiving an authorization query from the cellular network;
providing the authorization query to a user;
upon receiving an answer to the authorization query from the user, sending the answer to the cellular network;
receiving authorization from the cellular network;
storing the authorization within a memory of the single motherboard computer;
upon subsequently powering on the single motherboard computer, automatically providing the authorization within the memory to the cellular network;
obtaining an input from a sensor connected to an I/O point among multiple I/O points coupled to the single motherboard computer,
wherein the sensor is configured to collect data about signal strength of an LTE or a 5G network using the Raspberry Pi coupled to the unmanned vehicle; and
performing a local computation based on the input from the sensor to generate a coverage map based on the signal strength of the LTE or the 5G network.

11. The method of claim 10, further comprising:
creating an Internet connection in a surrounding environment having no wired or Wi-Fi connection, by providing access to the cellular network through the modem.

12. The method of claim 10, wherein the single motherboard computer includes the multiple I/O points configured to receive a second sensor, the method further comprising:
detecting by the second sensor a mobile device in a surrounding environment; and
determining how a number of the mobile device in the surrounding environment varies over time.

13. The method of claim 10, wherein the single motherboard computer includes the multiple I/O points configured to couple to an environment sensor, the method further comprising:
measuring by the environment sensor a property of a surrounding environment including a temperature, humidity, a pollution; and
determining how the property of the surrounding environment varies over time.

14. The method of claim 10, further comprising:
communicating with a nearby device using Narrowband Internet of Things (NB-IoT).

15. The method of claim 10, further comprising:
reducing power consumption of a limited power supply by operating the processor in at least one of multiple power modes including a high-power, a medium power or a low power mode,
wherein the medium power mode stops a processor clock, and the low power mode stops a system clock and flash memory.

16. The method of claim 10, further comprising:
reducing power consumption of a limited power supply by operating the processor in at least one of multiple power modes including a high-power, a medium power or a low power mode,
wherein the processor transitions from the high-power mode to the medium power or the low power mode upon completion of handling pending interrupts and exceptions.

17. At least one non-transient, computer-readable medium, carrying instructions that, when executed by at least one data processor, performs a method comprising:
upon initially powering on a single motherboard computer with a processor and a modem configured to communicate through a cellular network using an LTE or a 5G technology, automatically detecting an available cellular network,
wherein the single motherboard computer is configured to couple to an unmanned vehicle, and
wherein the single motherboard computer comprises a Raspberry Pi;
automatically connecting to the detected cellular network;
providing a query to a user;
upon receiving an answer to the query from the user, sending the answer to the cellular network;
receiving authorization from the cellular network;
storing data associated with the authorization within a memory of the single motherboard computer;
obtaining an input from a sensor coupled to the single motherboard computer,
wherein the sensor is configured to collect data about signal strength of an LTE or a 5G network using the single motherboard computer coupled to the unmanned vehicle; and
performing a local computation based on the input from the sensor to generate a coverage map based on the signal strength of the LTE or the 5G network.

18. The non-transient, computer-readable medium of claim 17, further comprising:
creating an Internet connection in a surrounding environment having no wired or Wi-Fi connection, by providing access to the cellular network through the modem.

19. The non-transient, computer-readable medium of claim 17, further comprising:
reducing power consumption of a limited power supply by operating the processor in at least one of multiple power modes including a high-power, a medium power or a low power mode,
wherein the medium power mode stops a processor clock, and the low power mode stops a system clock and flash memory.

20. The non-transient, computer-readable medium of claim 17, further comprising:
reducing power consumption of a limited power supply by operating the processor in at least one of multiple power modes including a high-power, a medium power or a low power mode,
wherein the processor transitions from the high-power mode to the medium power or the low power mode upon completion of handling pending interrupts and exceptions.
